(19) United States
(12) Patent Application Publication
(10) Pub. No.: US 2012/0162221 A1
(43) Pub. Date: Jun. 28, 2012

(54) METHOD AND APPARATUS FOR STEREOSCOPIC MULTI-USERS DISPLAY

(75) Inventors: Robert Mark Stefan Porter, Winchester Hampshire (GB); Marco Volino, Hammersmith London (GB)

(73) Assignee: SONY CORPORATION, Tokyo (JP)

(21) Appl. No.: 13/387,926

(22) PCT Filed: Jul. 28, 2010
(86) PCT No.: PCT/GB10/51241

§ 371 Date: Mar. 15, 2012

(30) Foreign Application Priority Data
Aug. 6, 2009 (GB) 0913744.9

(51) Int. Cl. G06T 15/00

(52) U.S. Cl. 345/419

(57) ABSTRACT

A method of displaying different first and second 3D images on a display during a frame period. The first 3D image is formed of two stereoscopic images viewed by a first user through first shutter glasses and the second 3D image being a stereoscopic image is formed of two stereoscopic images viewed by a second user through second shutter glasses. The method includes: synchronizing display of the first stereoscopic image with the first shutter glasses and the second stereoscopic image with the second shutter glasses, wherein each stereoscopic image is displayed for a time period in synchronization with the respective shutter glasses, the time period being determined in accordance with the frame duration and the number of different 3D images being displayed on the display, wherein the brightness of the display in increased in accordance with the number of users being synchronized.

The present invention relates to a method and apparatus for viewing three dimensional (3D) images.

Stereoscopic vision is known. In stereoscopic vision, a flat object is given the perception of depth by presenting a slightly different image to each eye. When viewed together, these two images provide the illusion of depth.

It is possible to view stereoscopic images on television displays and computer monitors. In order to view these images and to achieve the illusion of depth, shutter glasses are used. One example of these is ReaID Pro® CrystalEyes 5® glasses. In general shutter glasses operate by alternately blanking each eye at the same rate as displaying the appropriate image on the display. In other words, as the lens covering the left eye is made opaque and the lens covering the right eye transparent, the right eye image is displayed. Similarly, as the lens covering the right eye is made opaque and the lens covering the left eye is made transparent, the left eye image is displayed on the screen.

Another technique for displaying stereoscopic images is by viewing a 3D display using polarised glasses. Polarised glasses have the lens covering one eye polarised to be transparent to only clockwise polarised light and the lens covering the other eye polarised to be transparent to, for example, only anti-clockwise polarised light. With polarised glasses having one anti-clockwise lens and one clockwise lens, the image for one eye is placed in the anti-clockwise field of the display and the image for the other eye is placed in the clockwise field on the display. As the eye covered by the clockwise lens cannot see the anti-clockwise fields on the display and vice versa, this arrangement provides the appropriate blanking to each eye. Other forms of polarisation are known such as linear or orthogonal polarisation.

Both of these techniques only ever allow a single 3D image to be displayed at any one time.

It is an aim of the present invention to improve the viewing of 3D images in general.

One aspect of the present invention provides a method of displaying a plurality of different first and second 3D images on a display during a frame period, a first of the 3D images being formed of two stereoscopic images being viewable by a first user through first shutter glasses and a second of the 3D images being formed of two stereoscopic images viewable by a second user through second shutter glasses, the method comprising the steps of:

synchronising the display of the first stereoscopic image with the first shutter glasses and the second stereoscopic image with the second shutter glasses, wherein each stereoscopic image is displayable for a time period in synchronisation with the respective shutter glasses, the time period being determined in accordance with the frame duration and the number of different 3D images being displayable on the display.

This is advantageous because it allows any number of three dimensional images to be viewed by a number of different users on the same display. This is particularly advantageous because the number of users, and as such the number of different three dimensional images is scalable depending on the requirements of the user.

The first and second shutter glasses may include polarised lenses and the display includes polarised lines for display, whereby the first and second 3D image is displayable on the polarised lines in accordance with the polarisation of the lenses of the respective users.

This is useful because the use of polarised lenses means that the length of time each image is displayed to each eye increases for any given number of users viewing the display. This reduces the flicker sometimes associated with shutter glasses.

According to another aspect, there is provided a method of displaying a plurality of different first and second 3D images on a display during a frame period, a first of the 3D images being formed of two stereoscopic images being viewable by a first user through first shutter glasses and a second of the 3D images being formed of two stereoscopic images viewable by a second user through second shutter glasses, the method comprising the steps of:

synchronising the display of the first stereoscopic image with the first shutter glasses and the second stereoscopic image with the second shutter glasses, wherein the first and second shutter glasses include polarised lenses and the display includes polarised lines for display, whereby the first and second 3D image is displayable on the polarised lines in accordance with the polarisation of the lenses of the respective users.

In any of the above circumstances, the brightness of the display may be increased from an initial level when the first and second shutter glasses are first synchronised to the display, wherein the increase in the level of brightness is determined in accordance with the number of users being synchronised.

As the number of users increase, there may be a perceived reduction in light levels for each user. To counter this, the brightness of the display may be increased.

The level of brightness may be increased proportionally to the number of users being synchronised.

The synchronisation of the display to the first and second shutter glasses may take place at the start of every frame period. This is useful because it allows users to stop watching the display without affecting the other users.

During synchronisation, information identifying each pair of glasses may be transmittable to the glasses and the identifying information indicates when, during the frame, the respective glasses are to be opaque or transparent.

The first and second stereoscopic images of the first 3D image may be displayable to the first user in sequence before the first and second stereoscopic images of the second 3D image are displayable to the second user. This is advantageous because it reduces processing requirements to display the images.

Alternatively, the first stereoscopic image of the first 3D image may be displayable to the first user immediately followed by the first stereoscopic image of the second 3D image being displayable to the second user. This is useful because it reduces the length of time each user will have no image displayed to them.

The increased level of brightness may be reduced over a predetermined time to the initial level. This reduces the amount of wear on the display.

The perspective of the first and second 3D image may be adjusted in dependence upon the position of the first and second user respectively.

The position of the first and second user may be determined by tracking the movement of the user relative to the image.

The position of the first and second user may be determined by the virtual location of the user within the image, the virtual location being determined by the first and second user respectively.

In another aspect, there is provided an apparatus for displaying a plurality of different first and second 3D images on a display during a frame period, a first of the 3D images being formed of two stereoscopic images being viewable by a first user through first shutter glasses and a second of the 3D images being a stereoscopic image being formed of two stereoscopic images viewable by a second user through second shutter glasses, the apparatus comprising:

a synchroniser for synchronising the display of the first stereoscopic image with the first shutter glasses and the second stereoscopic image with the second shutter glasses; whereby each stereoscopic image is displayable for a time period in synchronisation with the respective shutter glasses, the time period being determined in accordance with the frame duration and the number of different 3D images being displayable on the display.

The first and second shutter glasses may comprise polarised lenses and the display includes polarised lines for display, whereby the first and second 3D image is displayable on the polarised lines in accordance with the polarisation of the lenses of the respective users.

In another aspect, there is provided an apparatus for displaying different first and second 3D images on a display during a frame period, the first 3D image being formed of two stereoscopic images being viewable by a first user through first shutter glasses and the second 3D image being a stereoscopic image being formable of two stereoscopic images viewable by a second user through second shutter glasses, the apparatus comprising:

a synchroniser for synchronising the display of the first stereoscopic image with the first shutter glasses and the second stereoscopic image with the second shutter glasses; wherein the first and second shutter glasses include polarised lenses and the display includes polarised lines for display, whereby the first and second 3D image is displayable on the polarised lines in accordance with the polarisation of the lenses of the respective users.

The apparatus may comprise a brightness controller for increasing the brightness of the display from an initial level when the first and second shutter glasses are first synchronised to the display, wherein the increase in the level of brightness is determined in accordance with the number of users being synchronised.

The level of brightness may be increased proportionally to the number of users being synchronised.

The synchronisation of the display to the first and second shutter glasses may take place at the start of every frame period.

During synchronisation, information identifying each pair of glasses may be transmittable to the glasses and the identifying information indicates when, during the frame, the respective glasses are to be opaque or transparent.

The first and second stereoscopic images of the first 3D image may be displayable to the first user in sequence before the first and second stereoscopic images of the second 3D image are displayable to the second user.

The first stereoscopic image of the first 3D image may be displayable to the first user immediately followed by the first stereoscopic image of the second 3D image being displayable to the second user.

The increased level of brightness may be reduced over a predetermined time to the initial level.

In another aspect, there is provided a pair of shutter glasses comprising a memory operable to store a code distinguishing the pair of shutter glasses from other shutter glasses, and a transceiver operable to transmit the code to an apparatus according to any one of the embodiments and to receive from the apparatus information identifying when the glasses are to be transparent or opaque.

In another aspect, there is provided a pair of shutter glasses for viewing stereoscopic images comprising polarised lenses.

The lens in both eyes may have the same polarisation.

Alternatively, the lens in both eyes may have different polarisation.

Other respective features will become apparent from the description.

Embodiments of the present invention are described by way of example only and with reference to the accompanying drawings, in which:

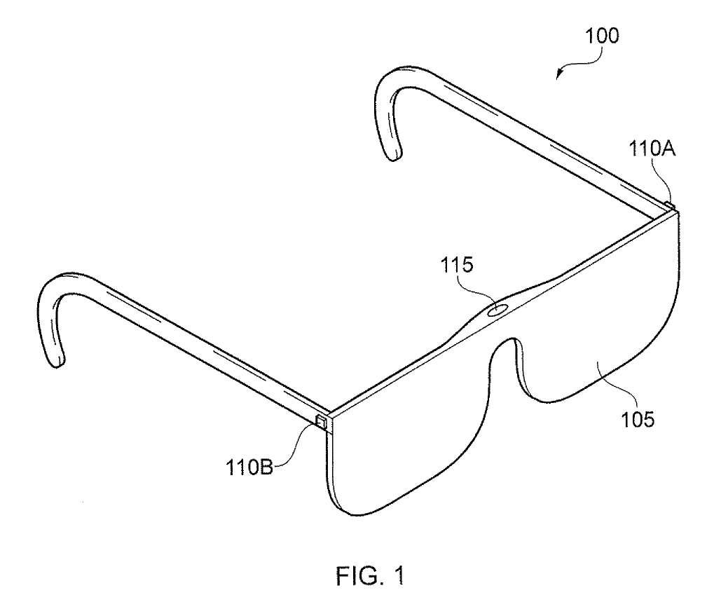

FIG. 1 shows eyewear according to one embodiment of the present invention;

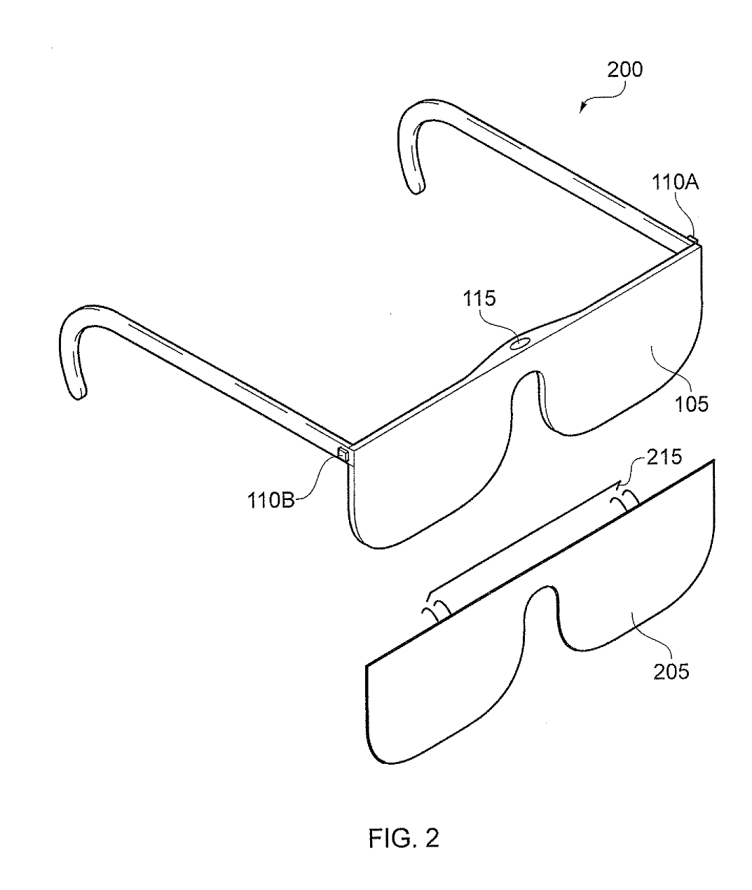

FIG. 2 shows eyewear according to a second embodiment of the present invention;

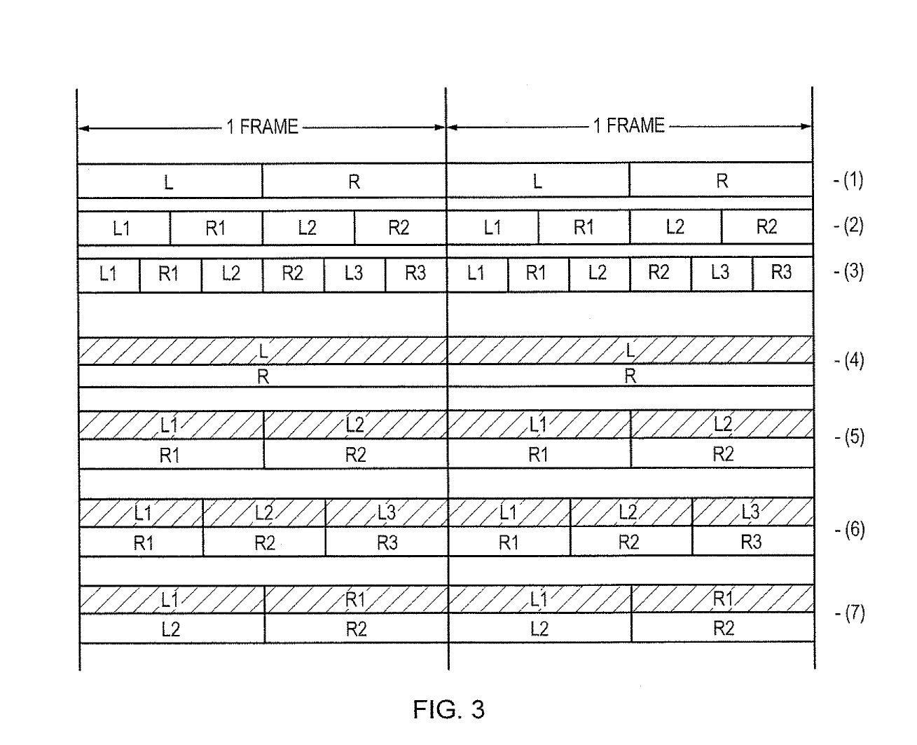

FIG. 3 shows a timing diagram explaining embodiments of the present invention;

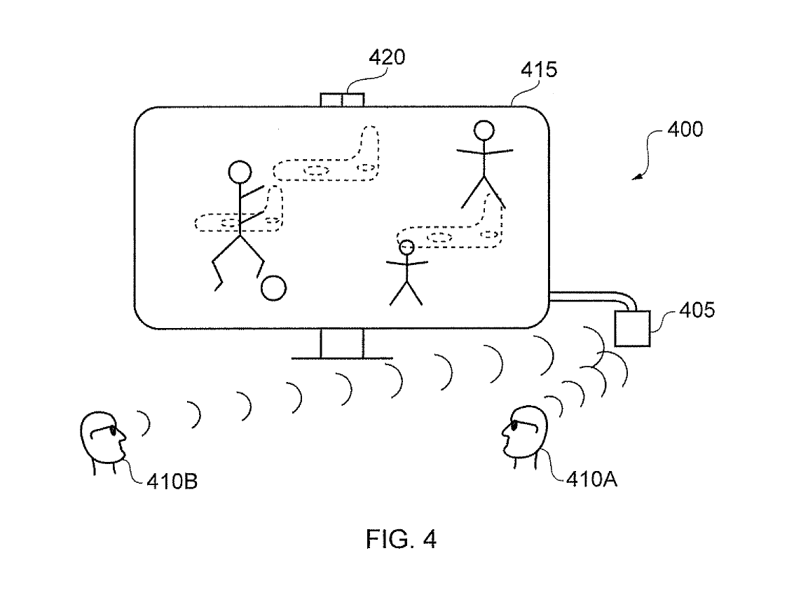

FIG. 4 shows a system according to embodiments of the present invention;

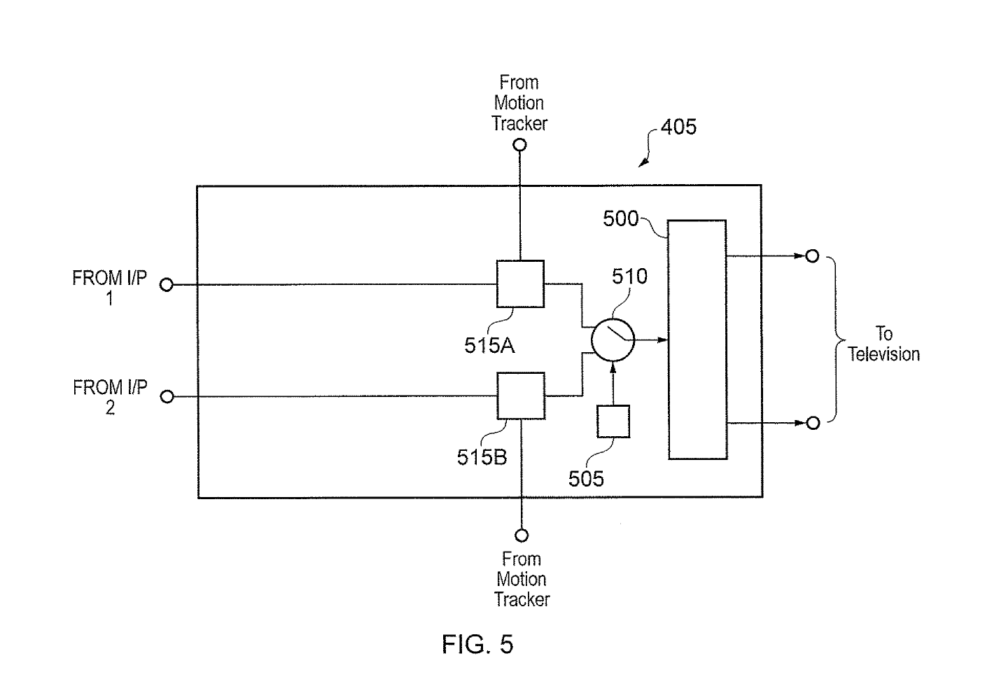

FIG. 5 shows an apparatus used in the system of FIG. 4; and

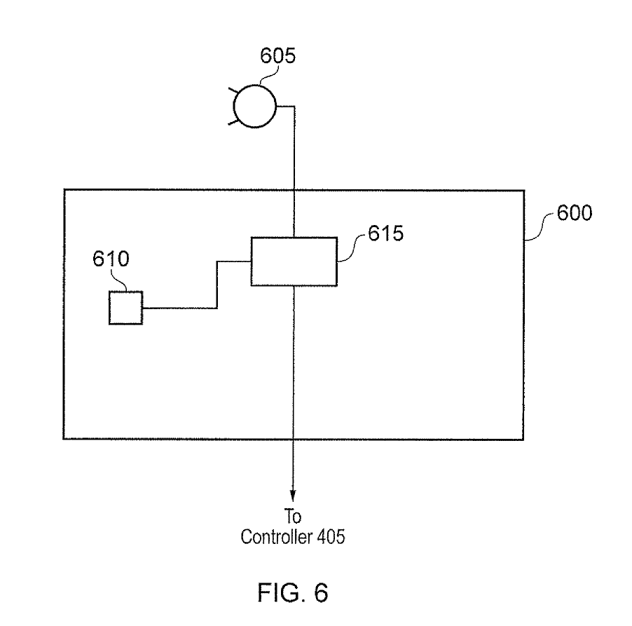

FIG. 6 shows a head tracking system that is used in embodiments of the present invention.

Referring to FIG. 1, a pair of shutter glasses 100 according to one embodiment of the present invention is shown. The shutter glasses 100 have a spectacles frame and a lens area 105. Unlike traditional spectacles, the lens area 105 contains Liquid Crystal cells. The Liquid Crystal cells are driven by voltages to either be opaque or transparent. In other words, by applying a voltage across the liquid crystal cell, the lens can either be opaque of transparent. In embodiments of the present invention, the lens covering the left and the right eye are driven to be out of phase such that when the lens over the left eye is transparent, the lens over the right eye is opaque and vice versa.

In order for the wearer of the shutter glasses 100 to correctly view the 3D image, the appropriate image (for either the left eye or right eye) is displayed in synchronisation with the operation of the Liquid Crystal cells. The synchronisation and appropriate timing for the operation of the shutter glasses according to embodiments of the present invention will be described later with reference to FIG. 3.

Additionally attached to the shutter glasses 100 are two infra-red light emitting diodes (LED) 110A and 110B. These emit infra-red and are separated on the shutter glasses 100 by a predetermined amount. The infra-red LEDs face in the same direction as the user's head and will be used for motion tracking as will be explained later. Additionally, provided on the shutter glasses 100 is a control circuit 115. The control circuit 115 includes a timing circuit that periodically receives a synchronisation pulse from the display to ensure that the glasses are synchronised with the display. Along with the synchronisation pulse, each pair of glasses receives information identifying when, during that frame, it needs to make each eye opaque and transparent. This allows for users to switch their glasses on and off during a viewing session so that not all users have to switch the glasses on and off at the same time and gives users the freedom to control their own viewing experience. Additionally, the control circuit 115 contains a memory which stores a code uniquely identifying the glasses. Further, the control circuit 115 controls the switching of the lenses as well as controlling the infra-red LEDs. In order for the glasses to operate, a battery (not shown) is located in the glasses 100.

Referring to FIG. 2, a pair of shutter glasses 200 according to another embodiment is shown. In this embodiment, the shutter glasses 200 may be conventional shutter glasses or may be the shutter glasses of the first embodiment discussed in FIG. 1. In either case, the shutter glasses 200 are capable of having attached thereto a polarisation lens 205. The polarisation lens 205 connects to the shutter glasses 200 using clips 215. The polarisation lens 205 has one lens (covering one eye) that is polarised in the clockwise direction and the other lens (covering the other eye) polarised in the anti-clockwise direction. Again, the operation of the glasses 200 according to this embodiment will be described with reference to FIG. 3. As the skilled person will appreciate, although the shutter glasses 200 are described as having the polarisation lens 205 clipped thereto, any further method of applying polarisation to lenses (covering eyes) is envisaged. One such alternative is polarisation coating on the lens.

Referring to FIG. 3, a timing diagram showing the operation of the shutter glasses in FIGS. 1 and 2 is shown. In particular, diagrams 2 and 3 show the operation of the shutter glasses of FIG. 1 and diagrams 5, 6 and 7 shows the operation of the shutter glasses of FIG. 2. In FIG. 3, the timings are shown with respect to the duration of one frame of video. Typically, the duration of this frame is 1/50^{th} second or 1/60^{th} second for PAL and NTSC television standards. However, any period is envisaged. In particular, it is possible to match the duration of a frame to the refresh rate of the display on which the image is to be displayed. For example, for a typical computer monitor, the frame may be 1/75^{th} second in duration.

Diagram 1 shows a timing diagram for a known pair of shutter glasses. Before use, a synchronisation pulse is sent from the display to the shutter glasses. This allows the shutter glasses to synchronise with the display so that appropriate images are displayed at the appropriate time and appropriate lenses are made transparent and opaque at the appropriate time. This synchronisation of the glasses to the display is known and so will not be explained further.

After synchronisation, at the start of one frame, the left eye is transparent (meaning the right eye is made opaque) and the left eye image is displayed on the screen. After a predetermined time period (which for one user is half of the frame—i.e. after 1/100^{th} second or 1/120^{th} second depending on the duration of the frame), the right eye is made transparent and the left eye is made opaque and the right eye image is displayed on the screen.

Diagram 2 shows a timing diagram for a pair of shutter glasses 100 according to an embodiment of the present invention. As will be appreciated, with the shutter glasses 100 of embodiments of the present invention, a plurality of users can view completely different video streams in 3D. Diagram 2 shows a timing diagram for two users viewing different 3D images on the same display.

The shutter glasses 100 of FIG. 1 for each user synchronises with the display. In order to synchronise, each pair of shutter glasses receives a synchronisation signal at the start of each frame. The synchronisation signal contains information identifying each pair of glasses (this is established during the set-up phase explained later), and informing each pair of glasses when during the frame each lens must be made opaque. By providing this information every frame, the stability of the synchronisation circuit within the pair of shutter glasses can be lower. This reduces complexity of the circuit, as well as size of the circuit.

After synchronisation, at the start of one frame the lens covering the left eye of the first user is kept transparent meaning that the lens covering the right eye of the first user is made opaque. The image for the left eye of the first user is displayed. It should be noted here that during this period, both the left and right eye of the second user is made opaque. This stops the second user from seeing any of the display meant for the first user.

After a predetermined time (which for two users is quarter of a frame—i.e. after 1/200^{th} second or 1/240^{th} second depending on the length of the frame), the lens covering the right eye of the first user is made transparent and the lens covering the left eye of the first user is made opaque. The image for the right eye of the first user is displayed. It should be noted here that during this period, both the left and right eye of the second user is kept opaque.

After another period of the predetermined time, the left eye of the second user is made transparent and the right eye of the second user is kept opaque. The image for the left eye of the second user is displayed. During this period, both the left eye and right eye of the first user is made opaque.

After another period of the predetermined time, the right eye of the second user is made transparent and the left eye of the second user is made opaque. The image for the right eye of the second user is displayed. During this period, both the left eye and right eye of the first user is kept opaque.

The process is repeated for the second and subsequent frames. It should be noted here that this particular ordering of both eyes of the first user being displayed in sequence followed by both eyes of the second user being displayed in sequence is useful. As both users are viewing different images, and because the user is viewing the respective image in 3D, by displaying the images for a user in sequence means that the processing power required at the display is reduced. This is because the image for the left eye and the right eye are very similar and so only a small amount of translation is required to get from one image to the next. However, if an image for one eye from one user was followed by an image for one eye from the second user, because these images are different, more processing power (for instance encoding) will be required at the display.

Although not shown, other sequences of shuttering are envisaged. For example, the lens covering the left eye of the first user may be made transparent in the first period (with the lens covering the other eye of the first user, and both lenses covering both eyes of the second user, being made opaque). The image for the left eye of the first user is then displayed. Following this, the lens covering the left eye of the second user is made transparent in the second period (with the lenses covering the other eye of the second user and both lenses covering both eyes of the first user being made opaque). The image for the left eye of the second user is displayed during this second period.

Similarly, in the third period the lens covering the right eye of the first user is made transparent (with the lens covering the other eye of the first user and both lenses covering both eyes of the second user being made opaque). The image for the right eye of the first user is displayed. In the fourth period the lens covering the right eye of the second user is made transparent (with the lens covering the other eye of the second user and both lenses covering both eyes of the first user being made opaque). The image for the right eye of the second user is displayed. This sequence of shuttering during each frame is advantageous because the period where both lenses of a user is opaque is reduced. This reduces the flicker effect associated with shutter glasses.

Diagram 3 shows the timing when three users are viewing three different images on one display in 3D. As will be appreciated, in diagram 3, each eye of each user will be transparent for ⅙^{th} of a frame i.e. 1/300^{th} second or 1/360^{th} second. As in diagram 2, the appropriate eye for the appropriate user is made transparent in synchronisation with the display of the appropriate image. Meanwhile, the other eye of that user and both eyes of the other users are made opaque during this time.

Diagram 4 shows the timing diagram for viewing 3D images using conventional polarised glasses. In contrast to timing diagram 1, where the images are fed to the appropriate eye at an appropriate time, timing diagram 4 shows the conventional use of anti-clockwise and clockwise polarised glasses. In diagram 4, the left eye of the only user views the display through an anti-clockwise polarised lens and the right eye of the only user views the display through a clockwise polarised lens. The image for the left eye is fed to the anti-clockwise polarised lines on a polarised 3D display and the image for the right eye is fed to the clockwise lines polarised on the 3D polarised display. Therefore, the left eye of the user is unable to see the image meant for the right eye and the right eye of the user is unable to see the image meant for the left eye.

Diagram 5 shows the timing diagram for the second embodiment of the present invention. In particular, diagram 5 shows the timing diagram for glasses 200 which is a combination of shutter glasses having polarised lenses.

After synchronisation (which in embodiments is the same method of synchronisation as discussed above with reference to timing diagram 2), at the start of the first period of a frame, the left eye and right eye of user 1 is transparent and both the left and right image for user 1 is displayed on the display at the same time. However, the image for the left eye of user 1 is displayed in the anti-clockwise fields of the display (which correspond to the anti-clockwise polarisation applied to the lens) and the image for the right eye of user 1 is displayed in the clockwise fields of the display (which correspond to the clockwise polarisation applied to the lens). The lens covering both the left and right eye of user 2 is made opaque.

After a predetermined time period (which is half of the frame—i.e. after 1/100^{th} second or 1/120^{th} second), both the left eye and the right eye are made transparent for user 2 and opaque for user 1. Again, the image for the left eye of user 2 is displayed in the anti-clockwise fields of the display (which correspond to the anti-clockwise polarisation applied to the lens) and the image for the right eye of user 2 is displayed in the clockwise fields of the display (which correspond to the clockwise polarisation applied to the lens). As can be seen from the timing diagrams, by using a combination of shutter glasses and polarised lenses, for the same number of users the rate at which the images are displayed is half that of using shutter glasses without polarised lenses. This is useful because it is appropriate to increase the brightness of the display when the time period for which the eye is exposed to the display is reduced (as explained later). Therefore, by decreasing the rate at which images are displayed (or increasing the time each image is exposed to the eye) it is possible to lower the brightness of the display. This increases the effective life of the display.

Diagram 6 shows a further embodiment of the present invention. In diagram 6 the shutter glasses 200 are the same as discussed in relation to FIG. 2 and the interaction of the polarisation in the lens and display is as explained with reference to diagram 5.

In particular, if there are three users wishing to view a 3D image, after synchronisation of all the glasses to the display, the lenses covering both eyes of the first user are made transparent for a predetermined period and for that period, the lenses covering both eyes of the second and third user are made opaque. In the case of three users, the predetermined period is 1/150^{th} or 1/180^{th} second. After the expiration of that period, the lenses in the glasses of the first user become opaque and the lenses in the glasses of the second user become transparent. The lenses of the glasses of the third user remain opaque. The lenses in the glasses remain in this state until the expiration of the period. At the expiration of the period, the lenses of the glasses of the third user become transparent and the lenses of the glasses of both the first and second user are opaque.

Although timing diagram 5 and 6 have the lens covering one eye of the first and second user being clockwise polarised and the other lens covering the other eye of the user being anti-clockwise polarised, the invention is not so limited. Indeed, user 1 could have both lenses clockwise polarised and user 2 could have both lenses anti-clockwise polarised. This arrangement is shown in timing diagram 7.

Referring to FIG. 4, a system 400 having a display 415, a controller 405, motion sensor 420 and a first user 410A and a second user 410B is shown. As can be seen from FIG. 4, both users are watching different images on the same screen 415. In particular, user 1 is watching an image of a soccer match (shown in solid lines), whereas user 2 is watching an image containing aeroplanes (shown in dashed lines).

Although FIG. 4 shows one user watching an image of a soccer match and the second user watching an image containing aeroplanes, it is noted that the invention is not so limited. For example, the users could be watching different television channels on the same television or playing different computer games, or even playing as different players in the same computer game. Additionally, embodiments of the invention could be used by groups of users, where multiple groups of users can view the display. In this case, one group of users has one image view and another group can have image view different from the first group. These embodiments could be used for general TV viewing, or watching sports where one set of fans sees the game from one end, and the opposition fans see the game from the other end. Additionally, this arrangement could be useful where two or more groups of users play team computer games, where each team sees different images.

Referring to FIG. 5, a schematic diagram of the controller 405 showing two different inputs for two different users is shown. Clearly, the present invention is not limited to any particular number of users, or groups of users, and any number of inputs can be received. Additionally, although only one line is shown for each user (for brevity) as would be appreciated, if the input image is in 3D, it is likely that two separate images/videos would be required for each user so that the 3D effect can be realised on the screen.

Each input line is fed into a controller 515A and 515B respectively. Additionally fed into the controllers 515A and 515B is position data from motion trackers. In embodiments there is one motion tracker for each user. As will be explained later the motion trackers track the movement and position of the user relative to the display. The position data is used to manipulate the foreground of the image relative to the position of the user. This known technology (sometimes called parallax mapping) gives the impression to the user that the foreground has depth. The controllers 515A and 515B use the information received from the motion trackers and apply parallax mapping to each input.

As would be appreciated, with 3D images, the perception of depth is already provided. Therefore, the position data provided by the motion tracker is used to adjust the perspective of the 3D images to a perspective view that is correct for the user. In other words, the perspective of the 3D is adjusted to be correct for the position of each user and additionally the correct parallax is formed for each of the foreground objects in the 3D image using parallax mapping. There are known techniques that allow adjustment of the perspective of the 3D image. By adjusting the perspective and performing parallax mapping, each user, when watching the screen, has a 3D image displayed that is correct for them relative to the screen/image.

If both users are watching the same soccer match on the screen, it is also possible to allow each of the the users to experience the effect of viewing the soccer match from different positions in the stadium. In other words, each user will be able to select a location within the scene (a virtual position) and place themselves at this position. As the view of each user is different, they experience the soccer match from a different perspective. Although the location of the user in the virtual image is determined by the user, it is possible to then allow the movement of the user within the room (i.e. movement determined by the motion tracking) to move the user within the virtual image. For example, if the user, whilst sat in the room moves two paces to the left, the view the user has in the virtual image will move two paces to the left. The advantage with allowing the different users to experience different views of the same match means that user will move without affecting the view of the other user or users.

Additionally, as each user has a different view of the soccer match (each view being independent of the other user), it is possible that each user can zoom in on the match and look more closely at one particular aspect of the match. Moreover, each user can position themselves in completely different parts of the stadium, for example behind opposite goals, and view the game from there. This gives each user the flexibility to view the game from anywhere within the stadium. This virtual positioning can be achieved using a manual controller or in conjunction with the head tracking device.

The parallax mapped images are then fed to a switching device 510. The switching device 510 is also connected to a synchronisation device 505. The synchronisation device 505 is used to synchronise the display to the shutter glasses which are used by the user to view the display as explained above. In other words, the synchronisation device 505 controls the switching device 510 to output either the left or right image for either the first or second user to a display controller 500. The display controller 500 encodes the image in an appropriate manner for the display and also provides luminance and brightness information for the display. The output of the display controller 500 is fed to the display.

In some cases, the images for each eye of each user is displayed for a very short period (as noted, for example, in timing diagram 3 of FIG. 3 each eye will have the image displayed for 1/360^{th} second). This means that if the display were simply shown using the traditional brightness parameters, the overall picture would look darker than normal. This is because of the reduction in photons reaching the eye during the period the lenses over each eye are made transparent. In order to mitigate this, the display controller 500 increases the brightness of the display by a level determined by the number of users at the start of the multiple displaying of images. So, as the number of users increases, the level of brightness also increases in proportion thereto. In the specific embodiments, therefore, if the number of users is two, the level of brightness would be doubled, and if the number of users is three, the level of brightness would be tripled.

However, it is envisaged that the level of brightness can be increased by any proportion when the number of users increases.

Having very high levels of brightness over prolonged periods of time can degrade the display. Therefore, the display controller 500 gradually reduces the levels of brightness from the peak levels at the start of the viewing to lower levels after a prolonged period (say, for example, 10 minutes). This drop in brightness levels will take place gradually and allows the users' eyes to become accustomed to the reduced brightness levels. Therefore, the number of users can be increased without damaging the display over prolonged periods of time.

As noted earlier, as the time period that the lenses are transparent varies depending on whether or not the glasses have polarised lenses, the level of brightness may also depend on whether or not shutter glasses with polarised lenses are used.

Referring to FIG. 6, the motion tracker 600 is connected to an infra-red camera 605. The infra-red camera 605 detects only infra-red light. In particular, the infra-red camera 605 is configured to only detect infra red light from one of the shutter glasses 100,200. As will be appreciated, if there are two or more users, each wearing a different pair of shutter glasses, the motion tracker 600 must differentiate between each user. In order to do this, each pair of shutter glasses 100,200 is authenticated with the corresponding motion tracker 600. This authentication takes place when the display is switched on. Each pair of shutter glasses has infra red LEDs attached thereto. These infra red LEDs are configured to output a specific code which uniquely identifies the shutter glasses. During authentication, this unique code is stored within the motion tracker 600 in a memory 610. The unique code is also fed to the synchronisation unit 505 to identify the respective glasses during synchronisation.

During regular operation, the received infra-red light is received by the infra-red camera 605 and is fed into an infra-red controller 615. The infra-red controller 615 determines whether the received infra red light originated from the shutter glasses it is to monitor. If the received light does not originate from the shutter glasses it is to monitor, the data will be ignored. However, if the received light does originate from the shutter glasses it is to monitor, the position of the light source (or in this case, the user wearing his or her shutter glasses) will be determined. This is established because the infra-red controller knows the distance between the infra-red LEDs on the glasses and also the distance between the received light dots. From this information, using the process of triangulation, the distance between the glasses and the display can be calculated. Additionally, knowing where on the camera lens the infra-red light is received, the position in the room of the user can be calculated using known techniques.

After establishing details of the location of the user, this information is fed to controller 405 so that appropriate parallax mapping can take place.

Although the motion tracking has been described such that one motion tracking device is required for one user, the skilled person will appreciate that more than one user can be authenticated with a single motion tracking device. This is because each user is uniquely identified to the motion tracking device at the authentication stage. Therefore, the memory 610 can store each authentication code and the motion tracking controller 615 can distinguish between each user and supply the appropriate information to the controller 405.

Also, although the foregoing is described using infra-red motion tracking, any other type of motion tracking may be used. Examples of this may include facial tracking and detection, whereby the orientation of the user's face can be easily established. This enables the direction of the user's eyes to be established thus improving the personalised 3D view for each user.

It is envisaged that embodiments of the invention will be performed by a microprocessor or computer. In this case, the invention may be embodied as a computer program which may be stored on a storage medium such as an optical disk or may be transmitted over the Internet or any kind of network.

1-29. (canceled)

30. A method of displaying a plurality of different first and second 3D images on a display during a frame period, a first of the 3D images being formable from two images which are stereoscopically viewable by a first user through first shutter glasses and a second of the 3D images being formable from two images which are stereoscopically viewable by a second user through second shutter glasses, the method comprising:
synchronizing display of the first stereoscopic image with the first shutter glasses and the second stereoscopic image with the second shutter glasses,
wherein each stereoscopic image is displayable for a time period in synchronization with the respective shutter glasses, the time period being determined in accordance with frame duration and a number of different 3D images to be displayed on the display, and
wherein the perspective of the first and second stereoscopic 3D image is adjustable in dependence upon a position of the first and second user respectively, wherein the perspective of the first and second user is determined by the virtual location of the user within the image, the virtual location being determined by the first and second user respectively.

31. A method according to claim 30, wherein brightness of the display is increasable from an initial level when the first and second shutter glasses are first synchronized to the display, wherein the increase in the level of brightness is determined in accordance with the number of users being synchronized.

32. A method according to claim 30, wherein the first and second shutter glasses comprise polarized lenses and the display includes polarized lines for display, whereby the first and second 3D image is displayable on the polarized lines in accordance with the polarization of the lenses of the respective users.

33. A method of displaying a plurality of different first and second 3D images on a display during a frame period, a first of the 3D images being formable from two images being which are stereoscopically viewable by a first user through first shutter glasses and a second of the 3D images being formable from two images which are stereoscopically viewable by a second user through second shutter glasses, the method comprising:
synchronizing display of the first stereoscopic image with the first shutter glasses and the second stereoscopic image with the second shutter glasses,
wherein the first and second shutter glasses include polarized lenses and the display includes polarized lines for display, whereby the first and second 3D image is displayable on the polarized lines in accordance with the polarization of the lenses of the respective users, and
wherein the perspective of the first and second stereoscopic 3D image is adjustable in dependence upon a position of the first and second user respectively, wherein the perspective of the first and second user is determined by the virtual location of the user within the image, the virtual location being determined by the first and second user respectively.

34. A method according to claim 33, wherein brightness of the display is increasable from an initial level when the first and second shutter glasses are first synchronized to the display, wherein the increase in the level of brightness is determined in accordance with the number of users being synchronized.

35. A method according to claim 30 or 33, wherein the level of brightness is increasable proportionally to the number of users being synchronized.

36. A method according to claim 30 or 33, wherein the display is synchronized to the first and second shutter glasses at a start of every frame period.

37. A method according to claim 30 or 33, wherein during synchronization, information identifying each pair of glasses is transmittable to the glasses and the identifying information indicates when, during the frame, the respective glasses are to be opaque or transparent.

38. A method according to claim 30 or 33, wherein the first and second images of the first stereoscopic 3D image are displayable to the first user in sequence before the first and second images of the second stereoscopic 3D image are displayable to the second user.

39. A method according to claim 30 or 33, wherein the first image of the first stereoscopic 3D image is displayable to the first user immediately followed by the first image of the second stereoscopic 3D image being displayable to the second user.

40. A method according to claim 31 or 34, wherein the increased level of brightness is to be reduced over a predetermined time to the initial level.

41. A method according to claim 30 or 33, wherein the position of the first and second user is determined by tracking movement of the user relative to the image.

42. An apparatus for displaying a plurality of different first and second 3D images on a display during a frame period, a first of the 3D images being formable from two images which are stereoscopically viewable by a first user through first shutter glasses and a second of the 3D images being a stereoscopic image formable from two images viewable by a second user through second shutter glasses, the apparatus comprising:
a synchronizer for synchronizing display of the first stereoscopic image with the first shutter glasses and the second stereoscopic image with the second shutter glasses, whereby each stereoscopic image is displayable for a time period in synchronization with the respective shutter glasses, the time period being determined in accordance with frame duration and a number of different 3D images to be displayed on the display; and
a controller operable adjust the perspective of the first and second stereoscopic 3D image in dependence upon a position of the first and second user respectively, wherein the perspective of the first and second user is determined by the virtual location of the user within the image, the virtual location being determined by the first and second user respectively.

43. An apparatus according to claim 42, further comprising a brightness controller for increasing brightness of the display from an initial level when the first and second shutter glasses are first synchronized to the display, wherein the increase in the level of brightness is determined in accordance with the number of users being synchronized.

44. An apparatus according to claim 42, wherein the first and second shutter glasses comprise polarized lenses and the display includes polarized lines for display, whereby the first and second 3D image is displayable on the polarized lines in accordance with the polarization of the lenses of the respective users.

45. An apparatus for displaying different first and second 3D images on a display during a frame period, the first 3D image being formable from two images which are stereoscopically viewable by a first user through first shutter glasses and the second 3D image being a stereoscopic image formable from two images viewable by a second user through second shutter glasses, the apparatus comprising:
a synchronizer for synchronizing display of the first stereoscopic image with the first shutter glasses and the second stereoscopic image with the second shutter glasses, wherein the first and second shutter glasses include polarized lenses and the display includes polarized lines for display, whereby the first and second 3D image is displayable on the polarized lines in accordance with the polarization of the lenses of the respective users; and
a controller operable to adjust the perspective of the first and second stereoscopic 3D image in dependence upon a position of the first and second user respectively,
wherein the perspective of the first and second user is determined by the virtual location of the user within the image, the virtual location being determined by the first and second user respectively.

46. An apparatus according to claim 45, further comprising a brightness controller for increasing brightness of the display from an initial level when the first and second shutter glasses are first synchronized to the display, wherein the increase in the level of brightness is determined in accordance with the number of users being synchronized.

47. An apparatus according to any one of claim 43 or 46, wherein the level of brightness is increased proportionally to the number of users being synchronized.

48. An apparatus according to either claim 42 or 45, wherein the display is to be synchronized to the first and second shutter glasses at a start of every frame period.

49. An apparatus according to either one of claim 42 or 45, wherein during synchronization, information identifying each pair of glasses is transmittable to the glasses and the identifying information indicates when, during the frame, the respective glasses are to be opaque or transparent.

50. An apparatus according to either one of claim 42 or 45, wherein the first and second images of the first stereoscopic 3D image are displayable to the first user in sequence before the first and second images of the second stereoscopic 3D image are displayable to the second user.

51. An apparatus according to either one of claim 42 or 45, wherein the first image of the first stereoscopic 3D image is displayable to the first user immediately followed by the first image of the second stereoscopic 3D image being displayable to the second user.

52. An apparatus according to either one of claim 43 or 45, wherein the increased level of brightness is to be reduced over a predetermined time to the initial level.

53. A pair of shutter glasses comprising:
a memory operable to store a code distinguishing the pair of shutter glasses from other shutter glasses; and
a transceiver operable to transmit the code to an apparatus according to either one of claim 37 or 40 and to receive information identifying when the glasses are to be transparent or opaque.

54. A pair of shutter glasses for viewing stereoscopic images comprising polarized lenses.

55. A pair of glasses according to claim 54, wherein the lens in both eyes has the same polarization.

56. A pair of glasses according to claim 54, wherein the lens in both eyes has different polarization.

57. A computer program containing computer readable instructions which, when loaded onto a computer, configure the computer to perform the method according to either claim 30 or 33.

58. A non-transitory computer storage medium configured to store the computer program of claim 57 therein or thereon.
